(19) United States
(12) Patent Application Publication
(10) Pub. No.: US 2011/0279342 A1
(43) Pub. Date: Nov. 17, 2011

(54) WIDEBAND ANTENNA HAVING A BLOCKING BAND

(75) Inventors: Fumio Takahashi, Kounosu-shi (JP); Hiroshi Shimizu, Kounosu-shi (JP); Hisamatsu Nakano, Kodaira-shi (JP); Shunichi Yamazaki, Kodaira-shi (JP)

(73) Assignee: NIPPON ANTENA KABUSHIKI KAISHA, TOKYO (JP)

(21) Appl. No.: 13/144,011

(22) PCT Filed: Oct. 29, 2009
(86) PCT No.: PCT/JP2009/005725

§ 371 Date: Jul. 11, 2011

(30) Foreign Application Priority Data
Feb. 5, 2009 (JP) 2009-024995

(51) Int. Cl. H01Q 9/04

(52) U.S. Cl. 343/845

(57) ABSTRACT

A wideband antenna including a ground element, and an antenna body provided on the ground element with a predetermined distance. The antenna body includes a feed element and a dielectric substrate, wherein an annular passive element is provided on the top surface of the dielectric substrate with a predetermined gap from the feed element. A plural short-circuit pins are equally spaced on the outer periphery of the passive element, whereby the passive element and the ground element 17 are connected by the short-circuit pins. A slit is formed on the passive element in the vicinity of the short-circuit pins. Since the slit is formed on the passive element, a resonance circuit having a resonance frequency dependant on the shape of the slit is formed on the passive element in the vicinity of the slit, whereby the radiation of the frequency component from the feed element is prevented.

### TECHNICAL FIELD

The present invention relates to an ultra wideband (UWB) antenna used for a high-speed wireless communication system.

### BACKGROUND OF THE INVENTION

UWB (Ultra Wide Band) communication system for a high-speed wireless communication system utilizes a wide bandwidth between 3.1 Hz and 10.6 GHz in order to diffuse data in a wide band for communication. This system saves power consumption, and has better anti-interference ability, and high-speed communication ability, so that the system attracts attention in various fields.

As the UWB system utilizes an extremely wide frequency band, so that an antenna working at an ultra wideband environment is required so as to facilitate an interference-free, low power consumption, while high efficiency signal transmission. An example of a patch antenna working at an ultra wideband environment is disclosed in a document described below.

### PRIOR ART

### Patent Document

Patent Document 1: Japanese Patent Application Laid-Open No. 2007-97115

### SUMMARY OF THE INVENTION

### Problem to be Solved by the Invention

FIG. 11 indicates a diagram illustrating an example of a structure of a patch antenna described in the above-mentioned document, wherein (a) is a perspective view, and (b) is a plane view. The patch antenna includes a feed element (radiation electrode) 94 provided on a ground element (ground electrode) 91 so as to be spaced with a predetermined distance, and an annular passive element (passive electrode) 92 surrounding the radiation electrode 94 with a gap 93. The passive element 92 is connected to the ground element 91 by plural short-circuit pins (connection electrode) 95-1 to 95-4. The feed element 94 is provided through a hole 96 formed on the ground element 91, wherein an external conductor is connected to a feed line 97 connected to the ground element 91.

When a wavelength of a central frequency of a transmitted signal is defined as λ, it is set such that the distance between the feed element 94 and the ground element 91 is 0.06λ, to 0.12λ, the length of the feed element 94 along an outer periphery is 0.1λ to 0.2λ, the distance between the outer periphery of the feed element 94 and the inner periphery of the passive element 92 is 0.33λ to 0.67 λ, and the width of the passive element 94 is 0.05λ to 0.1λ. Since the length of the passive element 92 along the outer periphery is set to be 0.9λ to 1.1λ, and the length of the passive element 92 along the inner periphery is set to be 0.4λ to 0.6λ, the frequency band is widened, which makes a fractional bandwidth of more than a dozen percent possible.

Since the UWB is a communication system utilizing a wide frequency band between 3.1 GH_{Z} and 10.6 GH_{Z}, it might interfere a frequency band employed by an existing wireless communication system such as wireless LAN utilizing 5 GH_{Z} band. Therefore, it is necessary that a transmitting apparatus of the UWB has a structure for avoiding interference with the other communication systems. For instance, in the above mentioned wireless LAN system, a structure of preventing a radiation of the band of 5 GH_{Z} has to be provided.

Conventionally, it is employed to add a filter, a slit, or the like to the transmitting apparatus of the UWB system, for preventing a certain frequency band. The method described above makes a configuration of the transmitting apparatus complex and a directivity of the UWB band system becomes unstable.

### Means for Solving the Problems

The present invention provides an antenna including a feed element provided on a ground element and a passive element that is provided on the ground element so as to surround the feed element and that is connected to the ground element by a short-circuit pin, wherein a slit is formed on the passive element in the vicinity of the short-circuit pins in order to form a blocking band in a desired frequency band.

### Advantages of the Invention

The present invention prevents a radiation of a desired frequency band by forming a slit on a passive element constituting a wideband antenna. Accordingly, a stable transmission property can be acquired without providing a configuration for preventing the frequency band with the transmitting apparatus. The central frequency, the bandwidth, and the inhibition rate of the blocking band can optionally be adjusted by changing the position and a shape of the slit.

In the present invention, the feed element is formed to have a rotating structure of an exponential (EXP) curve. This structure can provide an antenna with a low-profile posture and a simple structure.

### BRIEF DESCRIPTION OF THE DRAWINGS

FIG. 1(a) is a perspective view illustrating an overall wideband antenna according to a first embodiment of the present invention, and (b) is a view of a feed element.

FIG. 2(a) is a plane view of the antenna according to the first embodiment, and (b) is a partially enlarged view.

FIG. 3-1 is a table showing a structural dimension with which a property of the wideband antenna is measured.

FIG. 3-2(a) indicates a radiation pattern on X-Y plane, (b) indicates a radiation pattern on a vertical surface including a short-circuit pin, and (c) indicates a radiation pattern at the position of 45 degrees with respect to the vertical surface including the short-circuit pin at 2 GH_{Z}, according to the first embodiment.

FIG. 3-3(a) indicates a radiation pattern on X-Y plane, (b) indicates a radiation pattern on a vertical surface including a short-circuit pin, and (c) indicates a radiation pattern at the position of 45 degrees with respect to the vertical surface including the short-circuit pin, at 8 GH_{Z} according to the first embodiment.

FIG. 3-4(a) indicates a radiation pattern on X-Y plane, (b) indicates a radiation pattern on a vertical surface including a short-circuit pin, and (c) indicates a radiation pattern at the position of 45 degrees with respect to the vertical surface including the short-circuit pin, at 12 GH_{Z} according to the first embodiment.

FIG. 4-1(a) is a Smith chart indicating a relationship between a slit length and a frequency property in the first embodiment, and (b) is a view of an input impedance.

FIG. 4-2 is a view illustrating a relationship between a slit length and a VSWR in the first embodiment.

FIG. 4-3 is a table illustrating a relationship between a slit length and a wavelength in the first embodiment.

FIG. 5(a) is an overhead view of an antenna according to a second embodiment, and (b) is a detail view in which a part thereof is enlarged.

FIG. 6-1(a) is a view of a radiation pattern on X-Y plane, (b) is a view of a radiation pattern on a vertical surface including a short-circuit pin, and (c) is a view of a radiation pattern at the position of 45 degrees with respect to the vertical surface including the short-circuit pin, when the frequency is 2 GH_{Z} in the antenna according to the second embodiment.

FIG. 6-2(a) is a view of a radiation pattern on X-Y plane, (b) is a view of a radiation pattern on a vertical surface including a short-circuit pin, and (c) is a view of a radiation pattern at the position of 45 degrees with respect to the vertical surface including the short-circuit pin, when the frequency is 8 GH_{Z} in the antenna according to the second embodiment.

FIG. 6-3(a) is a view of a radiation pattern on X-Y plane, (b) is a view of a radiation pattern on a vertical surface including a short-circuit pin, and (c) is a view of a radiation pattern at the position of 45 degrees with respect to the vertical surface including the short-circuit pin, when the frequency is 12 GH_{Z} in the antenna according to the second embodiment.

FIG. 7-1(a) is a Smith chart indicating a relationship between a slit length and a frequency property in the second embodiment, and (b) is a view of input impedance.

FIG. 7-2 is a chart showing a relationship between a slit length and a VSWR in the second embodiment.

FIG. 7-3 is a chart showing a relationship between a slit length and a wavelength in the second embodiment.

FIG. 8(a) is a Smith chart indicating a relationship between a slit width and a frequency property in the second embodiment, and (b) is a view illustrating a VSWR-frequency characteristic.

FIG. 9-1 is a view illustrating another shape of the slit in the second embodiment.

FIG. 9-2(a) is a Smith chart indicating a relationship between a slit length and a frequency characteristic in FIG. 9-1, and (b) is a view illustrating a VSWR-frequency characteristic.

FIG. 10-1(a) is a view illustrating one example of a shape of a feed element, and (b) is a Smith chart illustrating the relationship between the shape of the feed element and the frequency characteristic.

FIG. 10-2(a) is a view illustrating a VSWR-frequency characteristic indicating the relationship between the shape of the feed element and the frequency characteristic, and (b) is a view illustrating a x₀-VSWR.

FIG. 11(a) is a perspective view illustrating a conventional wideband antenna, and (b) is an overhead view.

### EMBODIMENTS

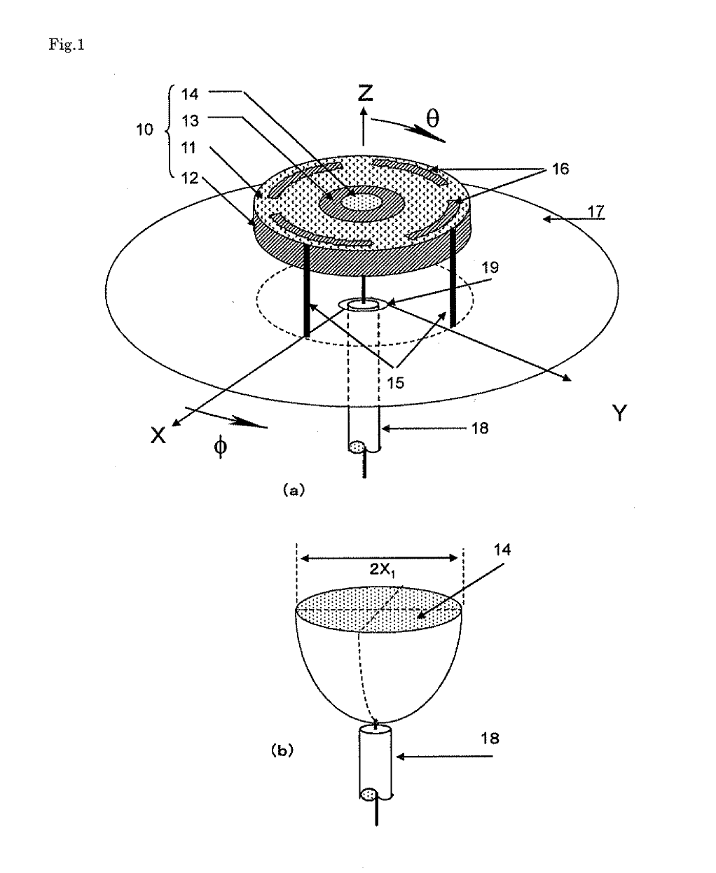

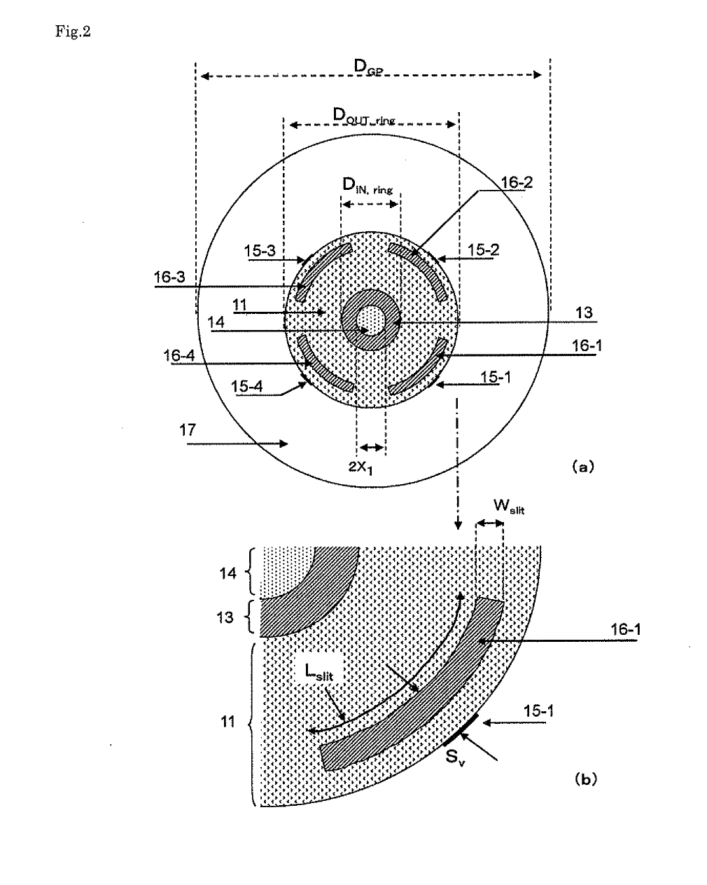

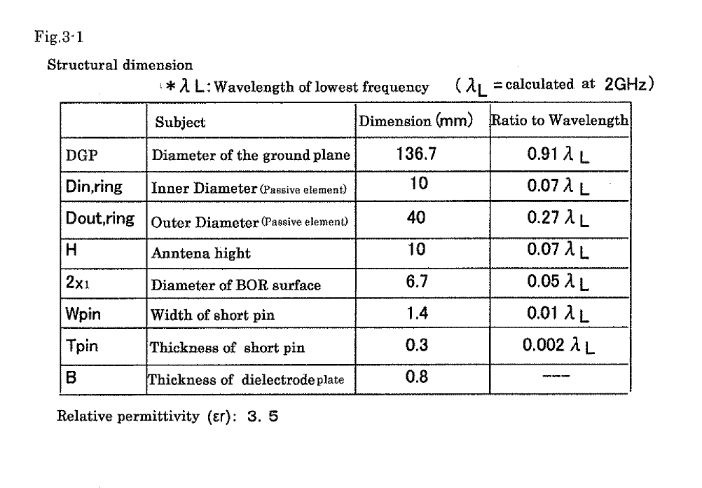

FIG. 1 shows a wideband antenna having a blocking band according to a first embodiment of the present invention, wherein (a) is an overall perspective view, and (b) is an enlarged view of a feed element. FIG. 2(a) is a plane view of the antenna of the first embodiment, and (b) is a partially enlarged view.

In FIG. 1(a), the antenna includes a ground element 17, and an antenna body 10 mounted on the ground element 17 with a predetermined distance. A feed element 14 having a diameter of 2X₁ is located at the center of the antenna body 10, and a dielectric substrate 12 is placed around the feed element 14. A through-hole 19 is formed on the ground element 17, and a feed line 18, having an external conductor connected to the ground element 17, is placed in the through-hole 19 to be connected to the bottom part of the feed element 14.

An annular passive element 11 is mounted on the top surface of the dielectric substrate 12 with a predetermined gap 13 from the feed element 14. Short-circuit pins 15 in a predetermined number (4 in the present embodiment) are equally spaced at the outer periphery of the passive element 11, whereby the passive element 11 and the ground element 17 are connected by the short-circuit pins 15. Slits 16 are formed on the passive element 11 in the vicinity of the respective short-circuit pins 15.

As illustrated in FIG. 1(b), the feed element 14 is a body of revolution of a logarithmic curve enlarging upwardly from the ground element 17 to the passive element 11. The circle of the top surface of the body of revolution is indicated as the feed element 14 in FIG. 1(b). The feed line 18 is connected to the bottom part of the body of revolution.

FIG. 2 is a plane view of the antenna illustrated in FIG. 1 according to the first embodiment. The ground element 17 is a disk having a diameter of D_{GP}. The antenna body 10 including the passive element 11, the dielectric substrate 12, and the feed element 14 is provided on the ground element 17 with a predetermined distance.

The feed element 14 (the top surface of the body of revolution illustrated in FIG. 1(b)) having the diameter of 2X₁ is located at the center of the antenna body 10.

The annular passive element 11 is provided on the top surface of the dielectric substrate 12 with the predetermined gap 13 from the outer periphery of the feed element 14. The diameter of the inner periphery of the passive element 11 is D_{IN, ring}, and the diameter of the outer periphery is D_{OUT, ring}.

Four short circuit-pins 15-1 to 15-4 are equally spaced around the outer periphery of the passive element 11, whereby the passive element 11 is connected to the ground element 17.

Slits 16-1 to 16-4 are formed on the passive element 11 in the vicinity of the respective short-circuit pins. FIG. 2(b) is a detail view illustrating the vicinity of the short-circuit pin 15-1 and the slit 16-1.

Each slit has, at its inside and outside, an arc concentric with the passive element 11, and its length is Lₛₗᵢₜ. The short-circuit pin is provided at the outer edge of the passive element 11 corresponding to the center of the slit. FIG. 2(b) illustrates that the short-circuit pin 15-1 provided on the outer edge of the passive element 11 is located at the center of the arc slit 16-1. The distance between the inner edge of the slit and the outer edge of the passive element 11 is designated as S_{V}.

A resonance circuit having a frequency in which the length Lₛₗᵢₜ of the slit corresponds to about a half a wavelength λ is formed by the feed element 14-gap 13-inner periphery of the passive element 11-slit 16-1-outer periphery of the passive element 11-short-circuit pin 15-1-ground element 17 as described above. The component of the frequency is not radiated from the radiation element 14, but becomes a blocking frequency.

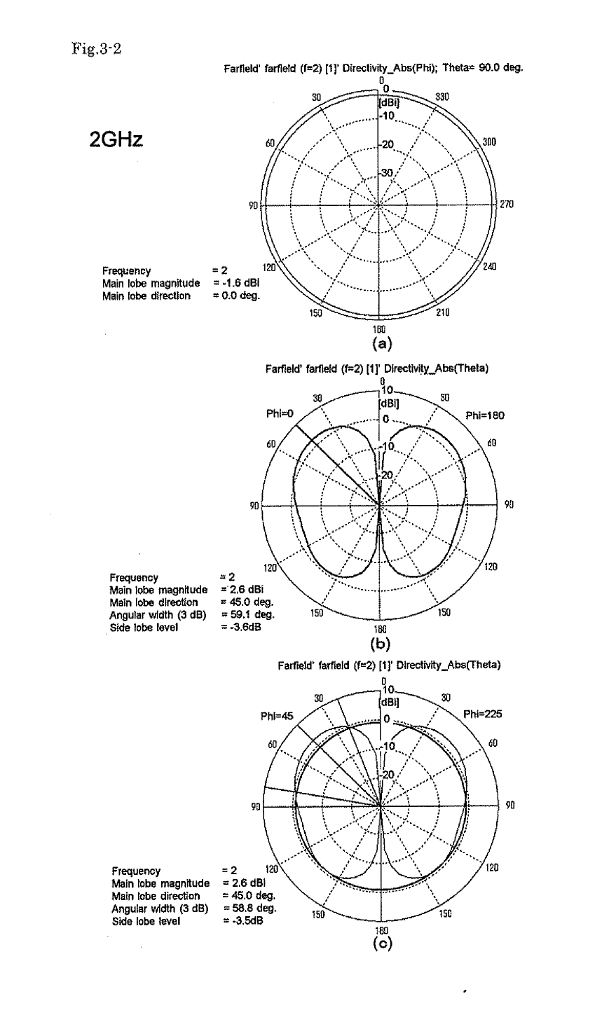

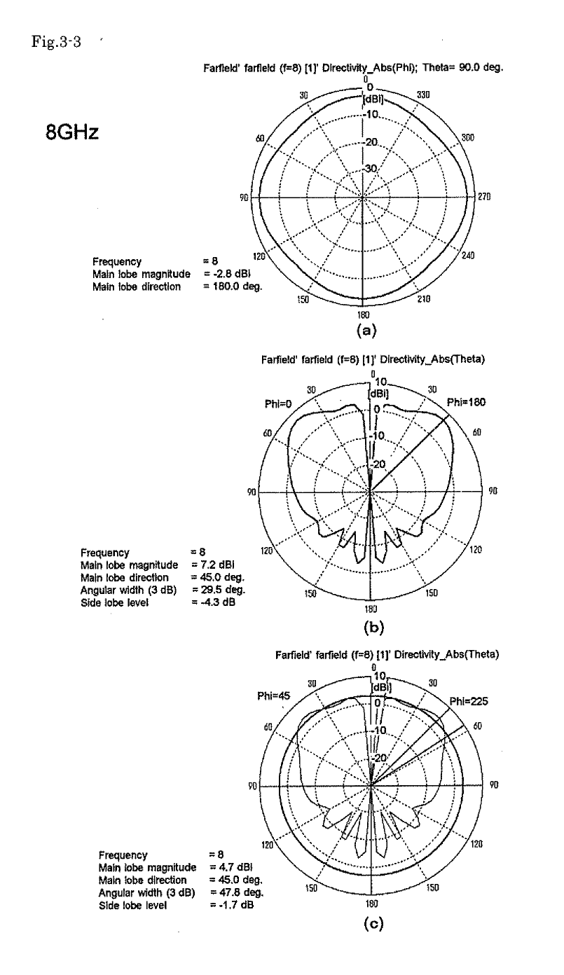

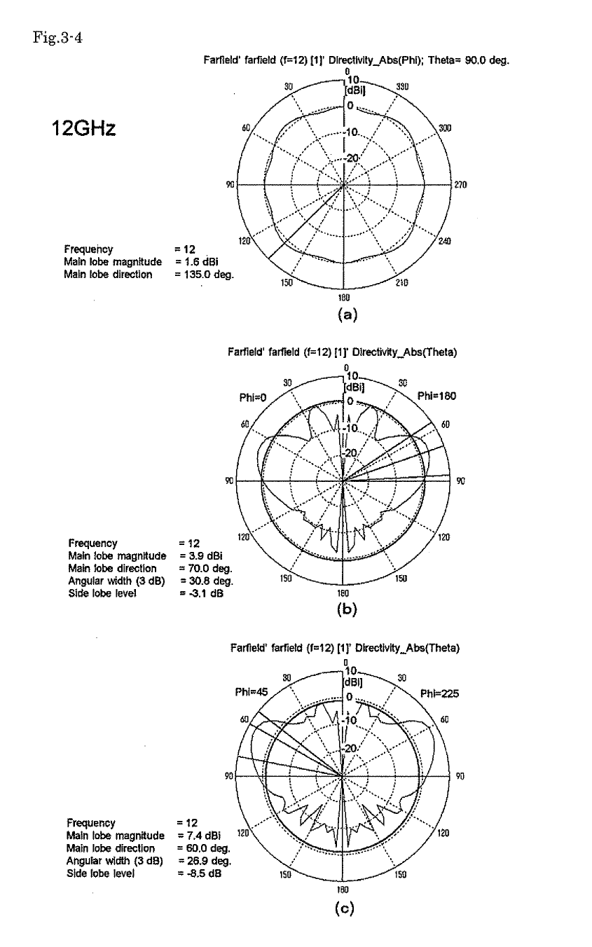

A table in FIG. 3-1 shows a structural dimension subjected to measurement of characteristics of the antenna according to the present invention. FIGS. 3-2 to 3-4 show a radiation pattern of the antenna according to the first embodiment illustrated in FIGS. 1 and 2, at frequency 2 GH_{Z}, 8 GH_{Z}, and 12 GH_{Z}, respectively. In each figure, (a) illustrates a radiation pattern of an X-Y plane, i.e., a surface (φ) parallel to the top surface of the antenna body 10. It is observed that the radiation in the horizontal direction, a radiation is substantially uniform in all directions and no unfavorable affects of the slits are observed.

FIG. (b) and (c) in each figure show radiation patterns of a vertical surface (θ) including a Z-axis, respectively, wherein the upper side is the zenith direction, and the lower side is the ground plane. The (b) in each figure shows a radiation pattern of the vertical surface including the short-circuit pins, while the (c) shows the radiation pattern of the vertical surface at an angle of 45 degrees with respect to (b), i.e., the vertical surface on which the slits are not locate. These figures shows that the radiation in the zenith direction is zero, and the radiation becomes the maximum at an angle of about 30 degrees to 60 degrees from the zenith direction, at any frequencies. It is also found that the radiation pattern rarely varies depending upon the position of the slit, and the radiation is uniform in all directions.

FIGS. 4-1 to 4-3 each shows a frequency characteristic of the antenna according to the first embodiment measured by changing the length Lₛₗᵢₜ of the slit 16 (wherein the width Wₛₗᵢₜ of the slit and the distance S_{V} from the inner diameter of the slit to the outer periphery of the passive element are fixed).

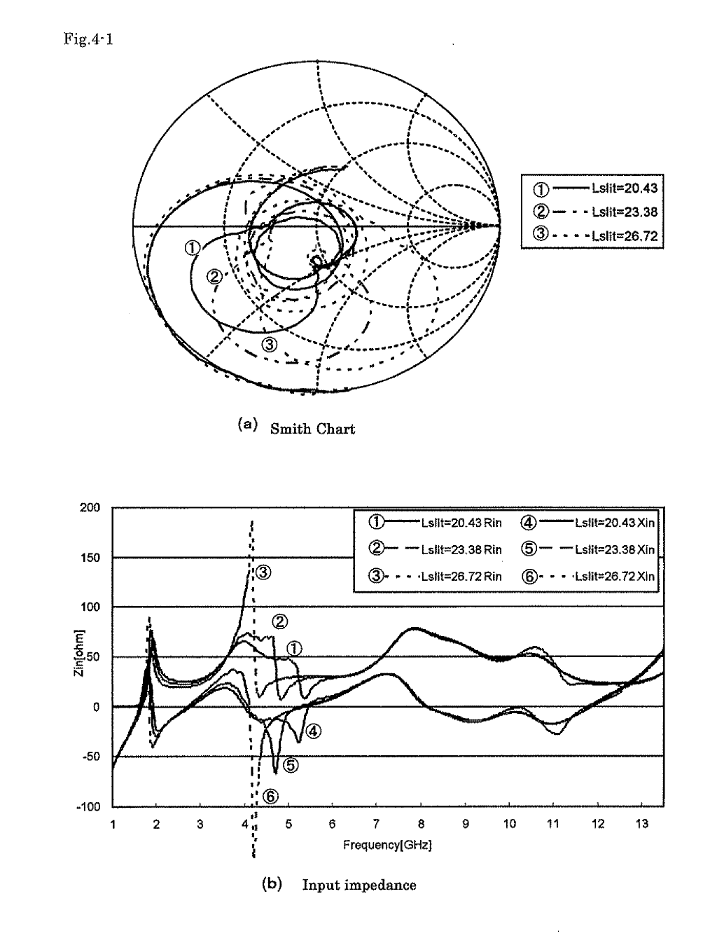

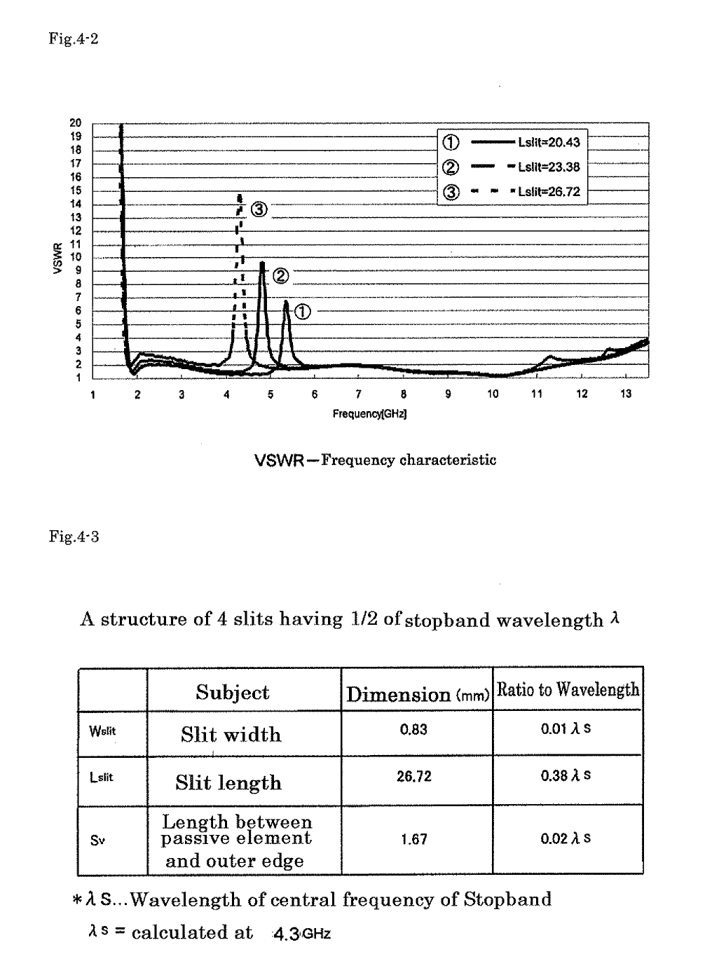

FIGS. 4-1a (1), (2), and (3) (the numbers correspond to circled numbers in the figure, hereafter the same). In FIG. 4-1(a) are Smith chart in which Lₛₗᵢₜ is 20.43 mm (1), 23.38 mm (2), and 26.72 mm (3); (1), (2), and (3) in (b) illustrate a real part of the impedance in which a horizontal axis indicates a frequency; and (4), (5), and (6) (circled numbers in the figure, the same is true below) illustrate an imaginary part, respectively. The (1), (2), and (3) in FIG. 4-2 illustrate the VSWR (voltage standing wave ratio)-frequency characteristic of each Lₛₗᵢₜ, respectively. FIG. 4-3 illustrates that the central frequency λ_{S} of the blocking band becomes about 4.3 GH_{Z} when the Lₛₗᵢₜ is 26.72 mm, and illustrates the ratio of λ_{S} to Wₛₗᵢₜ, Lₛₗᵢₜ, and S_{V}.

It is found from FIGS. 4-1 to 4-3 that, when the Lₛₗᵢₜ increases from (1), (2), to (3), the central frequency of the blocking band is inversely proportional to the Lₛₗᵢₜ to be shifted to the low band such as to about 5.4 GH_{Z}, 4.9 GH_{Z}, and 4.3 GH_{Z}.

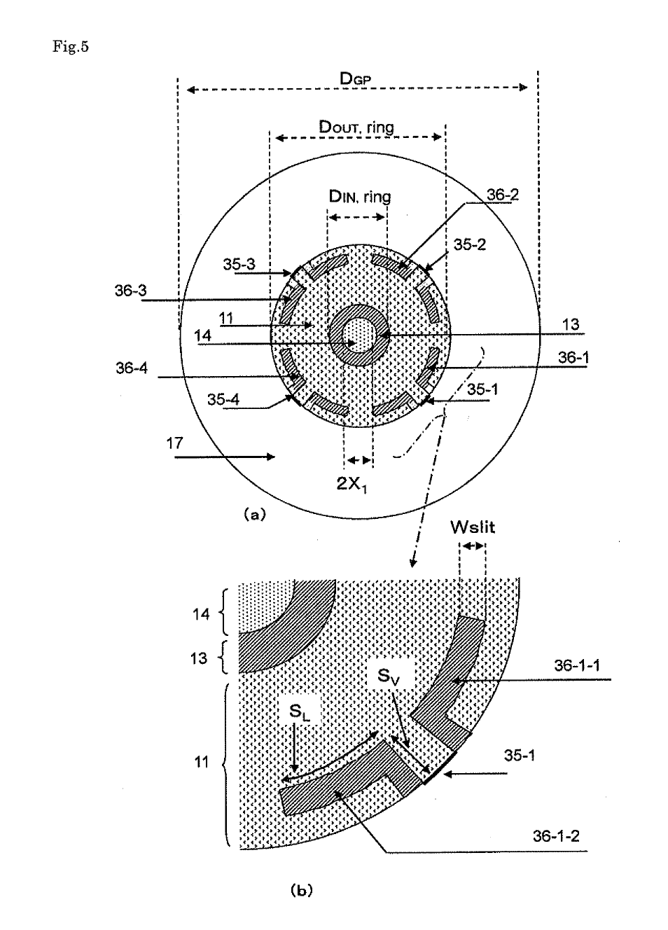

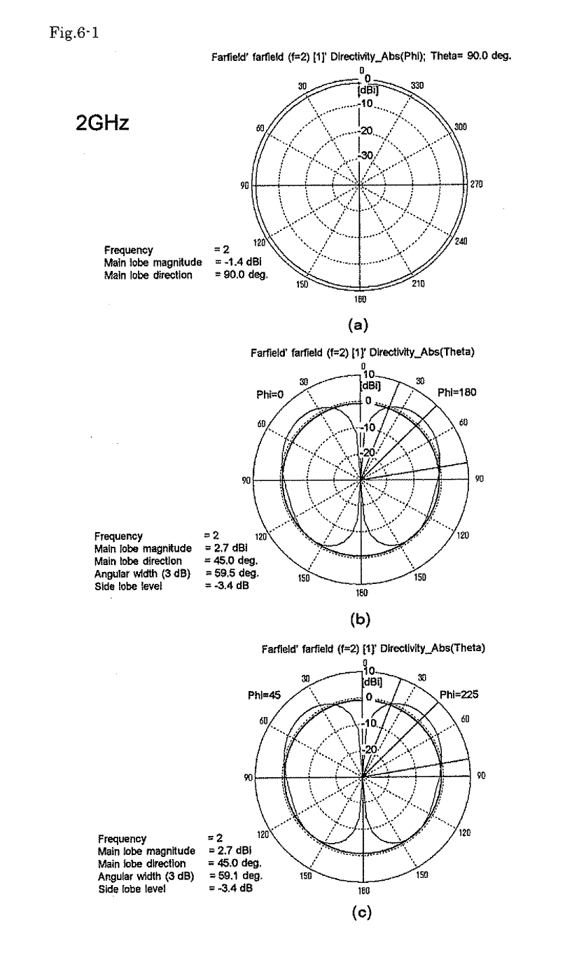

FIG. 5 shows a second embodiment of the present invention. In this embodiment, the slit formed on the passive element located in the vicinity of each short-circuit pin comprises a pair of L-shaped slit and a reversed L-shaped slit. FIG. 5(a) is a plane view of the antenna according to the second embodiment, and (b) is a partially enlarged detailed view. In the figure, the parts same as those in the first embodiment are designated as the same numerals in FIG. 2.

Like the first embodiment, four short-circuit pins 35-1 to 35-4 are equally spaced on the edge of the passive element 11. Pairs of slits 36-1 to 36-4, each pair including an L-shaped slit and a reversed L-shaped slit, are formed on the passive element 11 in the vicinity of the short-circuit pins.

FIG. 5(b) is a detailed view of the vicinity of the short-circuit pin 35-1 and the slit 36-1. The slit 36-1 is comprises a pair of an L-shaped slit 36-1-1 and a reversed L-shaped slit 36-1-2. One side of the L-shaped slit and the reversed L-shaped slit is an arc concentric with the edge of the passive element 11. The other side extends from the one end of the side to the edge of the passive element 11, thereby forming an opening to the edge.

The short-circuit pin 35-1 is provided at the edge of the passive element 11 where an opening of the L-shaped slit 36-1-1 and the reversed L-shaped slit 36-1-2 is formed.

The length of the one side of the slit 36-1-1 and the slit 36-1-2 in FIG. 5(b) is defined as S_{L}, the length of the second side is defined as S_{V}, and the width of each slit is defined as Wₛₗᵢₜ.

According to the structure of the second embodiment, a resonance circuit having a frequency in which the length S_{L}+S_{V} of the slit corresponds to about one-fourth a wavelength λ is formed by the feed element 14-gap 13-inner periphery of the passive element 11-slit 36-1-1 (and slit 36-1-2)-portion between the slit 36-1-1 and the slit 36-1-2 of the passive element 11-short-circuit pin 35-1-ground element 17 as described above, and the frequency is not radiated from the radiation element 14, but becomes a blocking frequency.

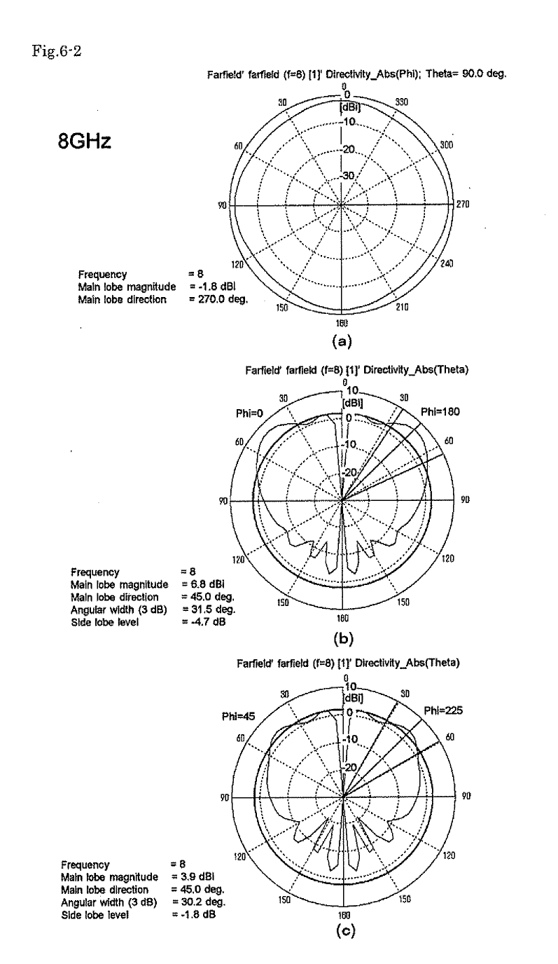

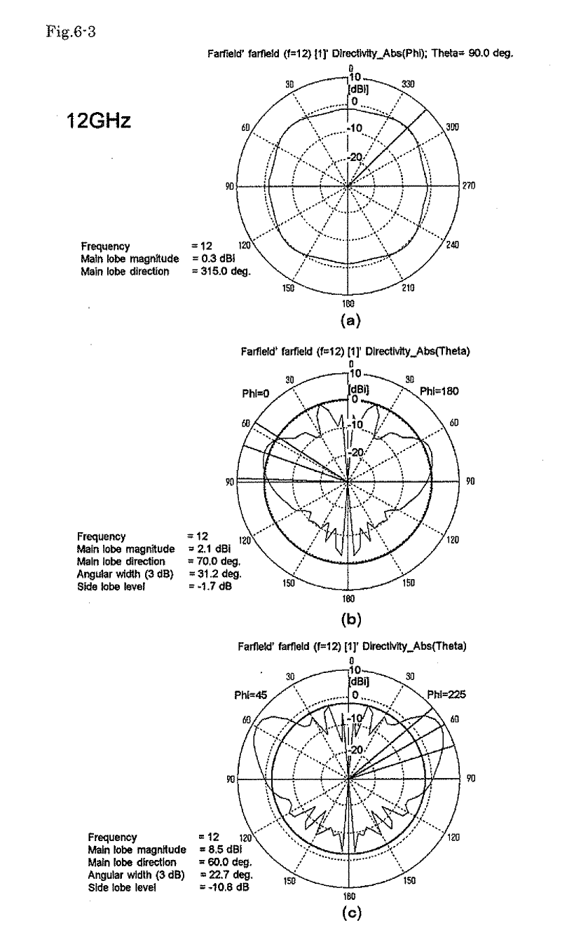

FIGS. 6-1 to 6-3 illustrate a result of a measurement in the second embodiment corresponding to FIGS. 3-2 to 3-4, respectively. It is observed from the figures that a substantially uniform radiation is observed in all horizontal directions without being affected by the presence of the slits at each frequency. From the radiation patterns in (b) and (c) of the figures, it is found that the radiation in the zenith direction of a Z-axis is zero, and the radiation becomes the maximum at an angle of about 30 degrees to 60 degrees from the zenith direction, at any frequencies. It is also found that the radiation pattern rarely varies depending upon the position of the slit, and the radiation is uniform in all directions.

FIGS. 7-1 to 7-3 each shows a frequency characteristic of the second embodiment, wherein the length Lₛₗᵢₜ (S_{L}+Sᵥ) of the slit is changed (the width Wₛₗᵢₜ of the slit is fixed at 0.83 mm).

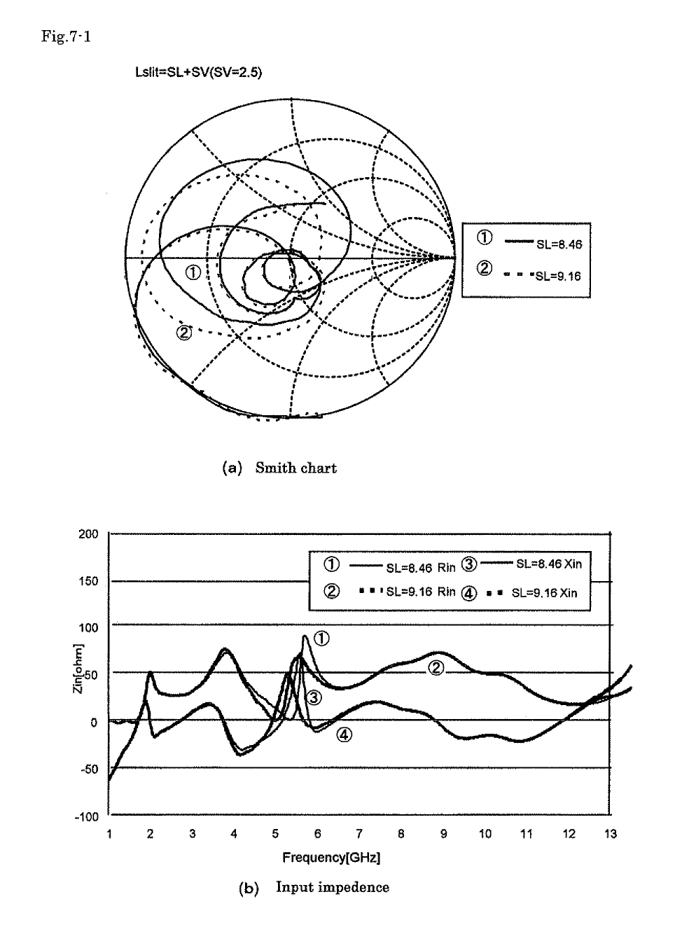

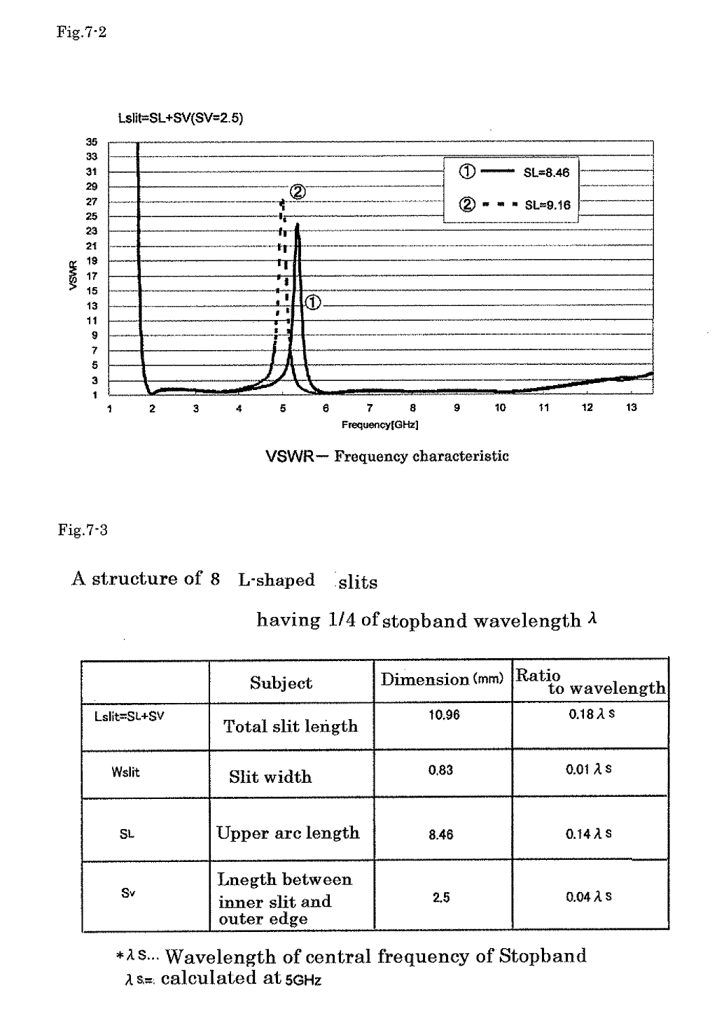

(1) and (2) in FIG. 7-1(a) is the Smith chart in which the distance from the inner diameter of the slit to the outer periphery of the passive element, i.e., the length S_{V} of the second side, is set to be 2.5 mm, and the length S_{L} of the first side is set to be 8.46 mm (1) and 9.16 mm (2). (1) and (2) in (b) illustrates a real part of the impedance in which the horizontal axis represents a frequency, while (3) and (4) illustrate an imaginary part, respectively. (1) and (2) in FIG. 7-2 illustrate a VSWR-frequency characteristic of each S_{L}, respectively. FIG. 7-3 illustrates that the central frequency λ_{S} of the blocking band becomes about 5.3 GH_{Z} when the S_{L} is 8.46 mm, and illustrates the relationship between the wavelength of the frequency and the length of the slit.

It is found from FIGS. 4-1 to 4-3 that, when the S_{L} is changed to (1) and (2), and the Lₛₗᵢₜ is set to be 8.46 mm and 9.16 mm, the central frequency of the blocking band is inversely proportional to the increase in the Lₛₗᵢₜ to be shifted to the low band such as to about 5.3 GH_{Z}, and 5.0 GH_{Z}.

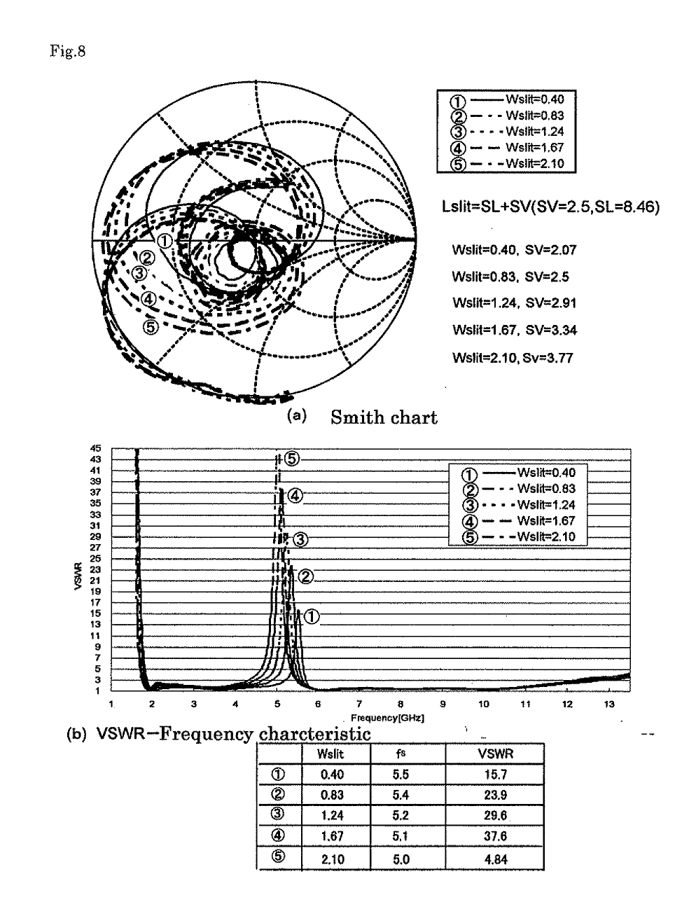

FIG. 8 shows a frequency characteristic of the antenna of the second embodiment, when the width Wₛₗᵢₜ of the slit is gradually increased (therefore, the length S_{V} of the second side also increases).

(1), (2), (3), (4), and (5) in FIG. 8(a) are the Smith chart when Wₛₗᵢₜ is 0.40 mm (1), 0.83 mm (2), 1.24 mm (3), 1.67 mm (4), and 2.10 mm (5), and (b) illustrates the VSWR-frequency characteristic in each Wₛₗᵢₜ. It is found from the figures that the central frequency fₛ in the blocking band is shifted to the low band, as well as the bandwidth of the blocking band increases, when the Wₛₗᵢₜ increases from (1), (2), (3), (4), to (5).

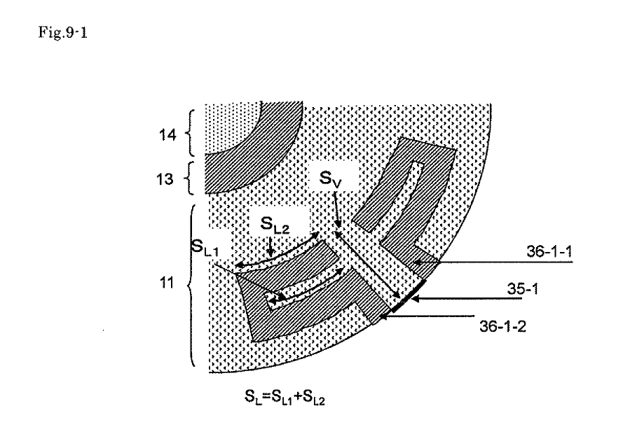

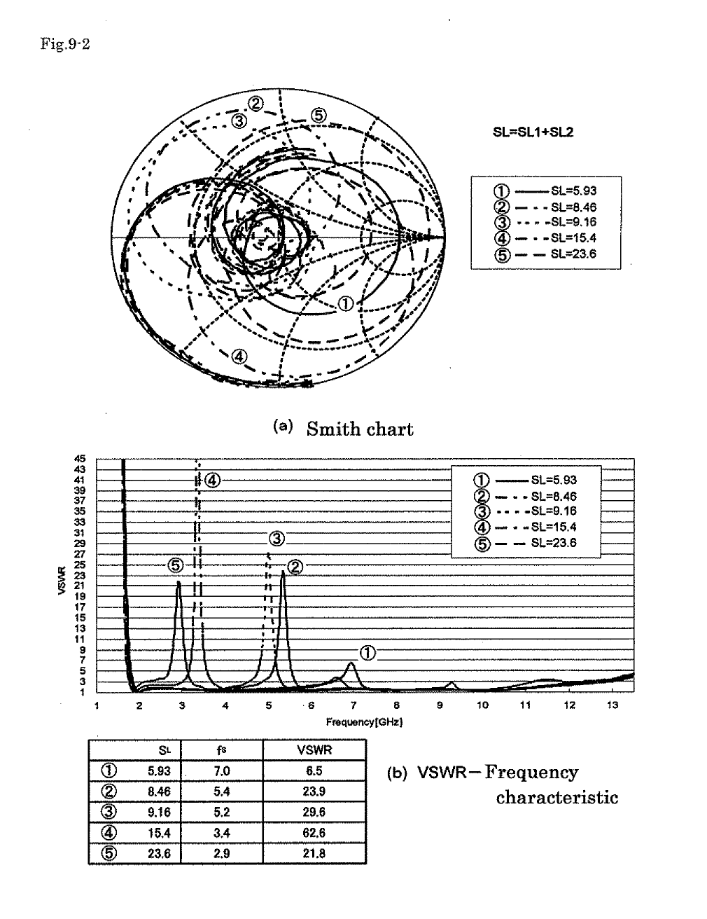

As shown in FIGS. 4-2 and 7-2, the central frequency of the blocking band can be shifted to the low band by elongating the slit. A structure of folded slit is possible as a method of elongating the slit. By folding the slit, the Lₛₗᵢₜ (S_{L}) increases, whereby the central frequency in the blocking band can be greatly shifted to the low band. FIG. 9-1 shows that, in the structure illustrated in FIG. 5, the first side of each of the L-shaped slit and the reversed L-shaped slit is folded to set S_{L} as S_{L1}+S_{L2}, which is substantially doubled.

(1), (2), (3), (4), and (5) in FIG. 9-2(a) are the Smith chart when S_{L} (S_{L1}+S_{L2}) is changed such as 5.93 mm (1), 8.46 mm (2), 9.16 mm (3), 15.4 mm (4), and 23.6 mm (5), and (b) illustrates the VSWR-frequency characteristic in each S_{L}. Compared to FIG. 7-2 and FIG. 9-2(b), it is found that the S_{L} increases such as 15.4 mm and 23.6 mm by folding the slit, whereby the central frequency in the blocking band is greatly shifted to the low band such as 3.4 GH_{Z} and 2.9 GH_{Z}.

In the present invention, it is possible to change the property of the blocking band by changing the shape of the feed element. FIGS. 10-1 and 10-2 each illustrate an example of a structure of the feed element that can adjust the property of the blocking band, that has a low-profile posture and a stable structure, and that can provide a stable property.

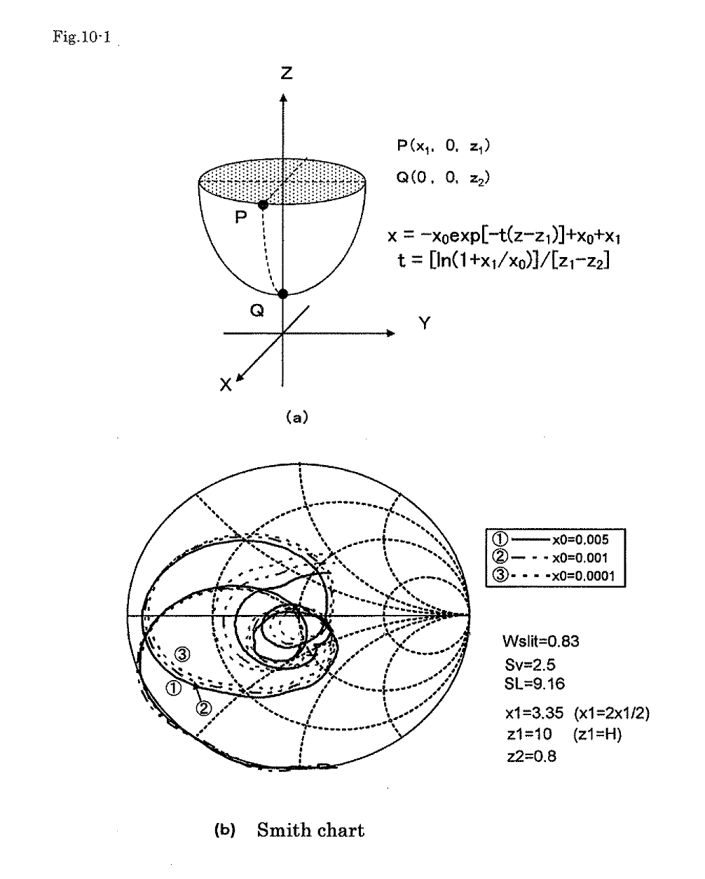

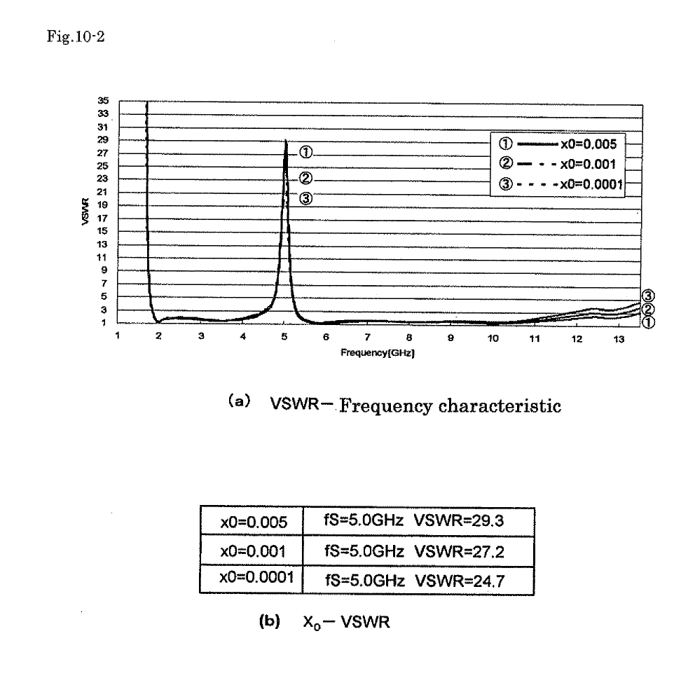

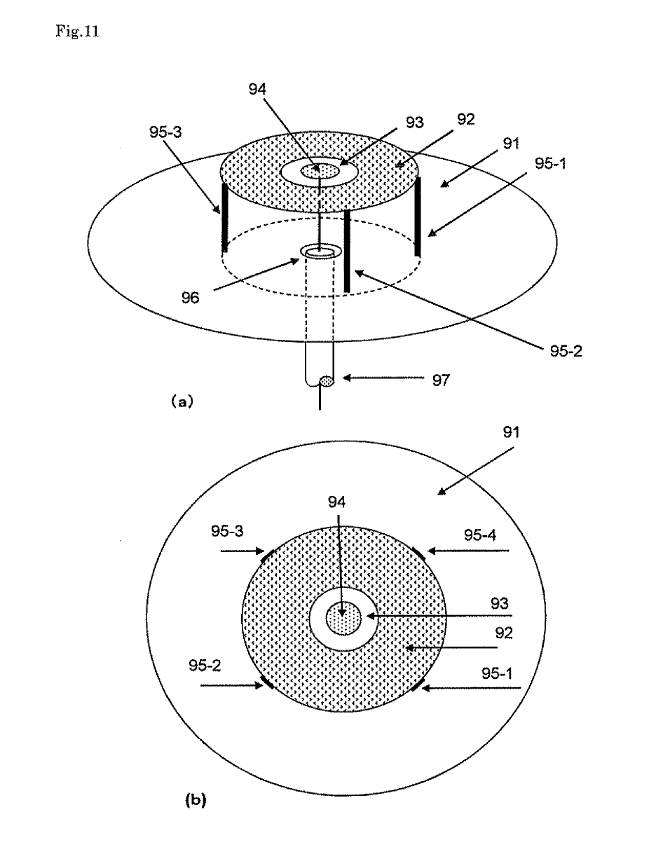

FIG. 10-1(a) illustrates one example of the shape of the feed element attaining the above-mentioned object. The shape is a body of revolution in which the portion between P point (x₁, 0, z₁) and Q point (0, 0, z₂) on the X-Z plane is defined as an exponential curve represented by

x=−x₀exp[−t(z−z₁)]+x₀+x₁

t=[ ln(1+x₁/x₀)/[z₁−z₂]

wherein the body of revolution is obtained by rotating the curve about the Z-axis. The shape of the feed element 14 is changed by changing x₀, x₁, z₁, and z₂, whereby the property of the blocking band can be adjusted.

FIG. 10-1(b) is the Smith chart in which x₀ is 0.005 (1), 0.001 (2), and 0.0001 (3). FIG. 10-2(a) is a VSWR-frequency characteristic corresponding to the x₀, and FIG. 10-2(b) illustrates the relationship among the x₀, the central frequency of the blocking band, and the VSWR.

It is found from the figure that the attenuation amount in the blocking band increases, when z₀ is fixed and x₀ is increased.

FIGS. 1 to 10-2 each illustrate the structure in which the feed element 14 is provided at the center of the dielectric substrate 12, and the passive element 11 is provided on its top surface. In the wideband antenna according to the present invention, the dielectric substrate 12 is not essential, and can be eliminated. In the structure in which the dielectric substrate 12 is eliminated, the passive element 11 and the feed element 14 can be fixed by the short-circuit pins 15-1 to 15-4 (or 35-1 to 35-4) and the feed line 18 so as to be separated from the ground element 17. Alternatively, they can be fixed by other support members so as to be separated from the ground element 17.

However, when the dielectric member is used between the passive element 11 and the ground element 17, the antenna can be downsized due to a dielectric constant (∈r) of the dielectric member.

$${λ}_{effect} = \frac{1}{\sqrt{\frac{1 + ɛ r}{2}}} \qquad [ Formula 1 ]$$

It is sufficient that the ground element 17 has a dimension greater than the outer diameter of the passive element 11. In the first and second embodiments, a circular conductor having an outer diameter of D_{GP} is used as the ground element. However, when the antenna is mounted to a vehicle, etc., a metallic body of the vehicle can be used as the ground element.

In the above-mentioned embodiments, the feed element and the passive element have the concentric shape. However, the present invention is applicable to an antenna including a feed element and a passive element, which are formed to have a square shape, not a circular shape, respectively.

### INDUSTRIAL APPLICABILITY

The present invention relates to a wideband antenna including, on a ground element, a feed element, and a passive element that is mounted so as to be separated from the feed element with a predetermined space, and more particularly to a wideband antenna that can be utilized for a high-speed communication system utilizing a wideband such as UWB. In the UWB that utilizes wide frequency band, the frequency utilized by the UWB and the frequency band utilized by other communication system might compete against each other. Conventionally, a structure of preventing the competing frequency band is needed to a transmission apparatus, which leads to a complicated structure, and entails a problem of unstable property.

In the present invention, a slit is formed on the passive element located at the outer periphery of the feed element, whereby a resonance circuit having a desired frequency is formed for preventing the radiation of the frequency component from the antenna. The present invention can surely inhibit the radiation of the frequency band, which might compete, by a simple configuration in which the slit is formed on the passive element. When the shape of the slit is appropriately selected, e.g., when the width of the slit is changed, not only the central frequency of the blocking band but also the bandwidth and attenuation ratio can be set to be a desired value.

One embodiment of the present invention employs, as the feed element, a rotator of a logarithm curve which expands from the ground element toward the passive element. With this structure, the height of the antenna can be decreased, whereby the wideband antenna having a low-profile posture can be provided.

1. A wideband antenna comprising a feed element provided on a ground element, a passive element that surrounds the feed element with a gap, and plural short-circuit pins that connect the passive element to the ground element, wherein
a slit that generates a blocking band for preventing the radiation of a specific frequency is formed on the passive element in the vicinity of the connection pins.

2. The wideband antenna according to claim 1, wherein
the feed element and the passive element have a concentric shape, wherein the connection pins are equally spaced on the outer periphery of the passive element.

3. The wideband antenna according to claim 2, wherein
the slit is an arc concentric with the passive element.

4. The wideband antenna according to claim 2, wherein
the length of the slit is about λ/2, when the wavelength of the central frequency of the blocking band is defined as λ.

5. The wideband antenna according to claim 3, wherein
the length of the slit is about λ/2, when the wavelength of the central frequency of the blocking band is defined as λ.

6. The wideband antenna according to claim 2, wherein
the slit includes a pair of L-shaped slit and a reversed L-shaped slit.

7. The wideband antenna according to claim 6, wherein
the length of each of the L-shaped slit and the reversed L-shaped slit is about λ/4, when the wavelength of the central frequency of the blocking band is defined as λ.

8. The wideband antenna according to claim 1, wherein
the passive element is mounted on a surface of a dielectric substrate.

9. The wideband antenna according to claim 2, wherein
the passive element is mounted on a surface of a dielectric substrate.

10. The wideband antenna according to claim 3, wherein
the passive element is mounted on a surface of a dielectric substrate.

11. The wideband antenna according to claim 4, wherein
the passive element is mounted on a surface of a dielectric substrate.

12. The wideband antenna according to claim 5, wherein
the passive element is mounted on a surface of a dielectric substrate.

13. The wideband antenna according to claim 6, wherein
the passive element is mounted on a surface of a dielectric substrate.

14. The wideband antenna according to claim 1, wherein
the feed element is a body of revolution of a logarithm curve that expands from the ground element toward the passive element.

15. The wideband antenna according to claim 2, wherein
the feed element is a body of revolution of a logarithm curve that expands from the ground element toward the passive element.

16. The wideband antenna according to claim 3, wherein
the feed element is a body of revolution of a logarithm curve that expands from the ground element toward the passive element.

17. The wideband antenna according to claim 4, wherein
the feed element is a body of revolution of a logarithm curve that expands from the ground element toward the passive element.

18. The wideband antenna according to claim 5, wherein
the feed element is a body of revolution of a logarithm curve that expands from the ground element toward the passive element.

19. The wideband antenna according to claim 6, wherein
the feed element is a body of revolution of a logarithm curve that expands from the ground element toward the passive element.

20. The wideband antenna according to claim 14, wherein
the logarithm curve is
x=−x₀exp[−t(z−z₁)]+x₀+x₁.
t=[ ln(1+x₁/x₀)/[z₁−z₂]
between a point (x₁, 0, z₁) and a point (0, 0, z₂).

21. The wideband antenna according to claim 15, wherein
the logarithm curve is
x=−x₀exp[−t(z−z₁)]+x₀+x₁
t=[ ln(1+x₁/x₀)[z₁−z₂]
between a point (x₁, 0, z₁) and a point (0, 0, z₂).

22. The wideband antenna according to claim 16, wherein
the logarithm curve is
x=−x₀exp[−t(z−z₁)]+x₀+x₁
t=[ ln(1+x₁/x₀)/[z₁−z₂]
between a point (x₁, 0, z₁) and a point (0, 0, z₂).

23. The wideband antenna according to claim 17, wherein
the logarithm curve is
x=−x₀exp[−t(z−z₁)]+x₀+x₁
t=[ ln(1+x₁/x₀)[z₁−z₂]
between a point (x₁, 0, z₁) and a point (0, 0, z₂).

24. The wideband antenna according to claim 18, wherein
the logarithm curve is
x=−x₀exp[−t(z−z₁)]+x₀+x₁
t=[ ln(1+x₁/x₀)/[z₁−z₂]
between a point (x₁, 0, z₁) and a point (0, 0, z₂).

25. The wideband antenna according to claim 19, wherein
the logarithm curve is
x=−x₀exp[−t(z−z₁)]x₀+x₁
t=[ ln(1+x₁/x₀)/[z₁−z₂]
between a point (x₁, 0, z₁) and a point (0, 0, Z₂).
